(19) United States
(12) Patent Application Publication
(10) Pub. No.: US 2011/0248959 A1
(43) Pub. Date: Oct. 13, 2011

(54) VIRTUAL KEYBOARD ENTRY

(75) Inventor: William Diehl, Dove Canyon, CA (US)

(73) Assignee: Cisco Technology, Inc., San Jose, CA (US)

(21) Appl. No.: 12/756,789

(22) Filed: Apr. 8, 2010

(51) Int. Cl. G06F 3/042

(52) U.S. Cl. 345/175

(57) ABSTRACT

A control has up, down, left, and right controls, with a select control located adjacent to the directional controls (e.g., in the center) to allow a user to move an erroneously entered key on a virtual keyboard to a desired key and to select the desired key without requiring the user to take the user's eyes away from the virtual keyboard and to move the user's hands significantly. The virtual keyboard may be displayed on the control or on a separate remote device, such as a television.

### TECHNICAL FIELD

The present disclosure relates generally to virtual keyboard entry, and more particularly to correcting erroneously entered letter, number, and/or symbol keys.

### BACKGROUND

Keyboards on devices are used to enter information. A traditional keyboard for a computer or PC allows the user to enter information, create documents, access and search the Internet, create emails, etc. More recently, smaller devices are also incorporating keyboards to enter information. Some examples include PDAs, smart phones, and remote controls. However, due to the small sizes of some of these types of devices, the keyboard can sometimes be very small, such as on a Blackberry® phone. As a result, users may have difficulty pressing the desired letter, number, or symbol, especially users with larger fingers.

One solution is to have a virtual keyboard for the device. Virtual keyboards can be temporary larger displays of a keyboard, which may allow the user to more easily select the desired key. One example of this type of keyboard is the iPhone®, which displays a keyboard on screen when needed, such as creating a text message to send, entering a web site address, creating an email, etc. The user uses a finger to select the desired keys. When a selected key is not the desired one, the user uses a backspace key to delete the earlier entry and then attempts to select the desired key again. This can be cumbersome and frustrating, especially with repeated entry of erroneous keys.

Another type of virtual keyboard is associated with controls, which allows a user to enter information using arrow buttons on the control either on the screen of the control or on the screen of a display device, such as a television set. Typically, an on-screen menu is presented to the user with some sort of keypad (e.g., QWERTY or sequential). The user presses up, down, left or right arrows to move the selection to the desired key or entry and presses an okay or select button to select the key. If the selection is not correct, the user selects a backspace key to delete the entry and re-selects a key. Even without erroneous selections, this process can be cumbersome for the user to navigate through the keys using only arrows.

Accordingly, there is a need to easily navigate and select desired entries from a virtual keypad, as well as easily make corrections to erroneously entered keys.

### BRIEF DESCRIPTION OF THE DRAWINGS

FIG. 1 is a flowchart showing one embodiment of a method to select and correct entries on a virtual keyboard;

FIG. 2 shows a device having a virtual keyboard and arrows to correct entries according to one embodiment;

FIG. 3 is a block diagram of the device of FIG. 2 according to one embodiment;

FIG. 4 shows a system having a separate display and control that can be used to select and correct entries on the display according to one embodiment; and

FIG. 5 is a block diagram of the control of FIG. 4 according to one embodiment.

Same reference numbers indicate the same step or element in the figures.

### DESCRIPTION

### Overview

According to one aspect of the disclosure, a letter, symbol, or number is entered on a virtual keypad. If the device has a virtual keyboard with a touch pad interface, the key is entered by touching or tapping the desired key and waiting a predetermined amount of time or entering the next key. If the entry is incorrect (typically because the user tapped an adjacent key), the user can correct the entry by pressing a directional arrow, such as an up, down, left, or right arrow to the desired entry. If the entry is now correct, the user can press a select key to select the entry (or the entry is automatically selected after a predetermined period of time or when another key is selected by touching or tapping the virtual keyboard. The next key may then be entered. In one embodiment, the arrows and select key are located on one side of the device, with the select button in the middle of the four arrow keys, where the user may press the arrow or select keys with a single finger, such as the user's thumb.

In another embodiment, the device is a control that controls a virtual keyboard separate from the control, e.g., a free-space control. By pointing the control to a desired key from a virtual keyboard on a display device, such as a television screen, desired letters, numbers, or symbols may be selected. Once the control is pointed at the desired key, the user presses a select button to enter the key. If this turns out to be incorrect, the user may press an up, down, left, or right arrow to move the selection to an adjacent key. In one embodiment, the user may scroll to the desired key. When the correct entry is shown, selection is made by the user pressing a select key or automatically after a predetermined amount of time. The select button is in the middle of the four directional arrows or a scrolling means so that the user can simply move to and select a desired key with only one finger, such as a thumb.

As a result, the user can easily correct a keyboard entry without requiring the user to move or reposition the user's hands and/or eyes.

### Description of Example Embodiments

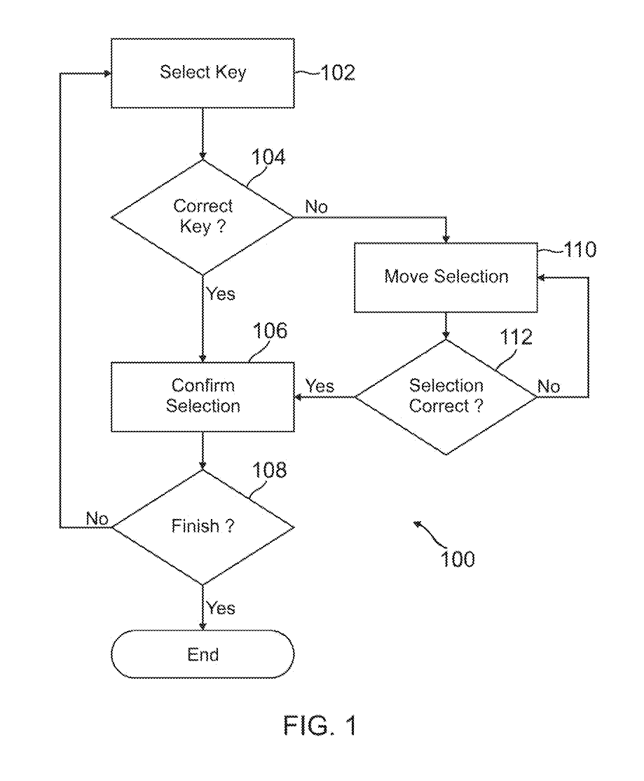

FIG. 1 is a flowchart showing a method 100 for correcting an entry on a virtual keyboard according to one embodiment. At step 102, the user enters a key (e.g., a letter, number, or symbol) on the virtual keyboard. The virtual keyboard may be any type of non-mechanical keyboard. Examples include an iPhone type screen with a touch-pad interface and a keyboard displayed on a device screen, such as a television screen. With the former, entry can be by a user tapping or touching a finger, pointer, or stylus on the desired key and waiting a predetermined amount of time or selecting a subsequent key. With the latter, entry can be made by the user pointing a control (e.g., a free-space control) at the screen and moving the control so that the desired key is entered.

Once the entry is made, a determination is made, at step 104, whether the selected entry is the desired or correct entry or key. If the selected entry is the desired one, the selection is confirmed at step 106. Confirmation may be accomplished by the user selecting, pressing, or touching a “select,” “enter,” or “ok” button, by the user simply waiting a predetermined amount of time without doing anything, entering a subsequent key, or other suitable means. Once confirmed, the user ends the process or selects the next entry at step 102, depending on whether the user has finished entering all the desired numbers, letters, and/or symbols, as determined at step 108.

If the determination is made at step 104 that the entry was incorrect, the user moves the selection, at step 110, up, down, left or right to the desired entry. An incorrect entry may occur if the user inadvertently taps/touches an adjacent key (usually directly adjacent to the desired entry), which may be relatively common due to the small size of many virtual keyboards. Incorrect entries may be especially susceptible with users having large fingers or attempting entry in an unstable environment, such as in a moving car, walking, or on a plane. With a free-space control, the user may mistakenly point the control at an entry adjacent to the desired entry due to such factors as distance, accuracy of the control, environmental conditions (e.g., bright light), etc. It is noted that the correction is after entry of a key, where the initial entry may be with the user selecting a key and waiting a predetermined amount of time, with the user selecting a subsequent key, or with the user actively confirming or entering a key with a button.

In one embodiment, the movement at step 110 may be accomplished by the use of arrow keys, where each selection or press of the key by the user moves the entry up, down, left, or right one key. Movement can also be by other suitable means, such as a scroll pad, scroll wheel, or scroll knob. Once the user moves the entry, a determination is made, at step 112, whether the newly selected entry is correct. If so, the selection is confirmed as before. Typically, the incorrect key is only one key away from the desired key and thus movement by one key is usually sufficient to correct the entry. However, there may be situations where the correct entry or key is more than one key away, such as when the user is bumped when making the initial entry. In this case, the determination at step 112 is that the newly selected entry is still incorrect. The user then moves the selection again, at step 110. This continues until the correct or desired entry is obtained. By allowing the user to use directional controls to move beyond adjacent keys, it is easier and quicker for the user to correct entries that are farther away, without requiring the user to sequentially select adjacent keys, such as in the case of moving along pre-set radio stations.

Using such a method, a user can quickly and easily make corrections to any erroneously selected key from a virtual keyboard without the user having to take time to look at the control, move the user's hands significantly, or other time consuming and cumbersome methods used previously. A set of arrow keys (or other suitable means) positioned with a select button such that the user can operate both with a single hand and a means for entering a key from a virtual keyboard using the other hand make this possible. The means for entering may be a touch pad interface with a virtual keyboard or a free-space control for pointing at a virtual keyboard on a separate display screen.

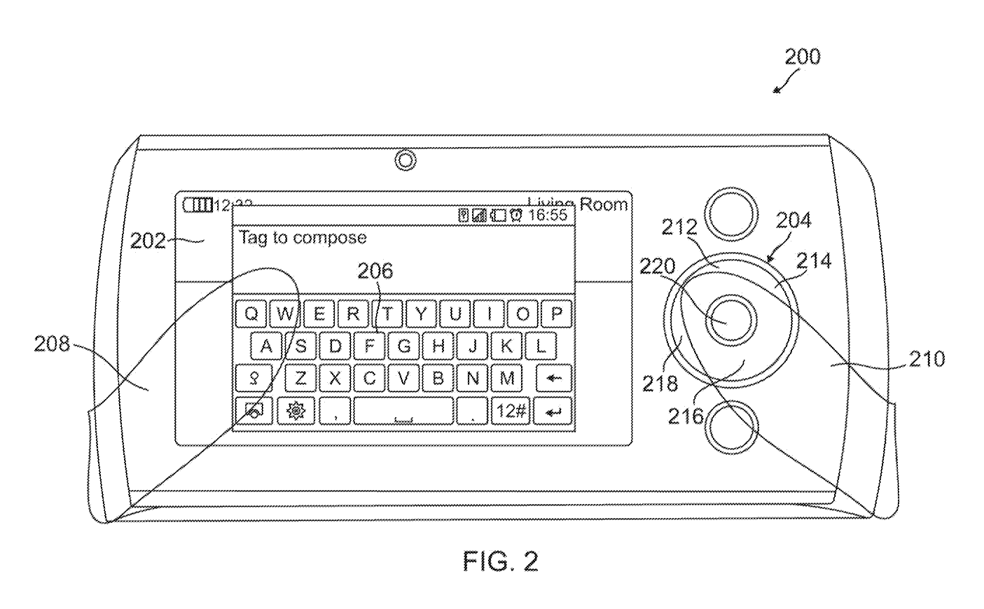

FIG. 2 shows a device 200 that can be used with the method of FIG. 1 according to one embodiment. Device 200 is a wireless control having an LCD touch screen 202 and a navigation wheel/selector 204. One example of device 200 is the DMRW1000 Wireless Home Audio Control, available from Linksys, a subsidiary of Cisco Systems, San Jose, Calif. Touch screen 202 can display a virtual keyboard 206 that allows a user to enter information by touching or tapping letters, symbols, and/or numbers on keypad 206 with a finger 208 and/or a finger 210. The information can be used for searching, such as music or videos by name, artist, album, show, etc. The information can also be used to enter system or user information, such as a pass code for the device.

If a key is incorrectly tapped, which would be evident to the user if a non-desired entry was shown on the screen and/or a temporary enlarged pop-up of the tapped key, the user can use navigation wheel/selector 204 to correct the entry. Navigation wheel/selector 204 has an upper area 212 (which can correspond to an up arrow), right area 214 (which can correspond to a right arrow), a lower area 216 (which can correspond to a down arrow), a left area 218 (which can correspond to a left arrow), and a select or okay button 220 in the center thereof. In other embodiments, select button 220 may be positioned elsewhere, such as directly below the navigation arrows or wheel. Table 1 below gives an example of when the user intended to select the letter G, the letter that was actually entered, and the action to correct the entry using navigation wheel/selector 204.

TABLE 1

| Desired Letter | Entered Letter | Action to Correct |
|---|---|---|
| G | F | Press the right arrow or area |
| G | T | Press the down arrow or lower area |
| G | Y | Press the down arrow or lower area |
| | | and then the left arrow or area |
| G | H | Press the left arrow or area |
| G | V | Press the up arrow or upper area |

Note that in Table 1, an incorrectly entered letter Y requires two actions due to the staggered positioning between the top and middle rows of virtual keyboard 206. The assumption is that pressing lower area 216 of wheel/selector 204 moves the entry from the letter Y to the letter H or from letter Y to letter G. In other words, if a letter was selected from the top row of virtual keyboard 206, the down arrow moves the selection to the right. Other devices or embodiments may move the selection differently when there is not a direct right, left, up, or down relationship between adjacent keys.

Once the selection is at the desired letter, number, or symbol, the desired may be selected by pressing select button 220 or simply waiting a predetermined amount of time (e.g., two seconds) without doing anything. As seen from FIG. 2, moving to the desired entry and selecting can be done with a single finger, while the other finger is still able to access virtual keyboard 206. This allows a quick and easy way for the user to correct erroneously entered keys on virtual keyboard 206.

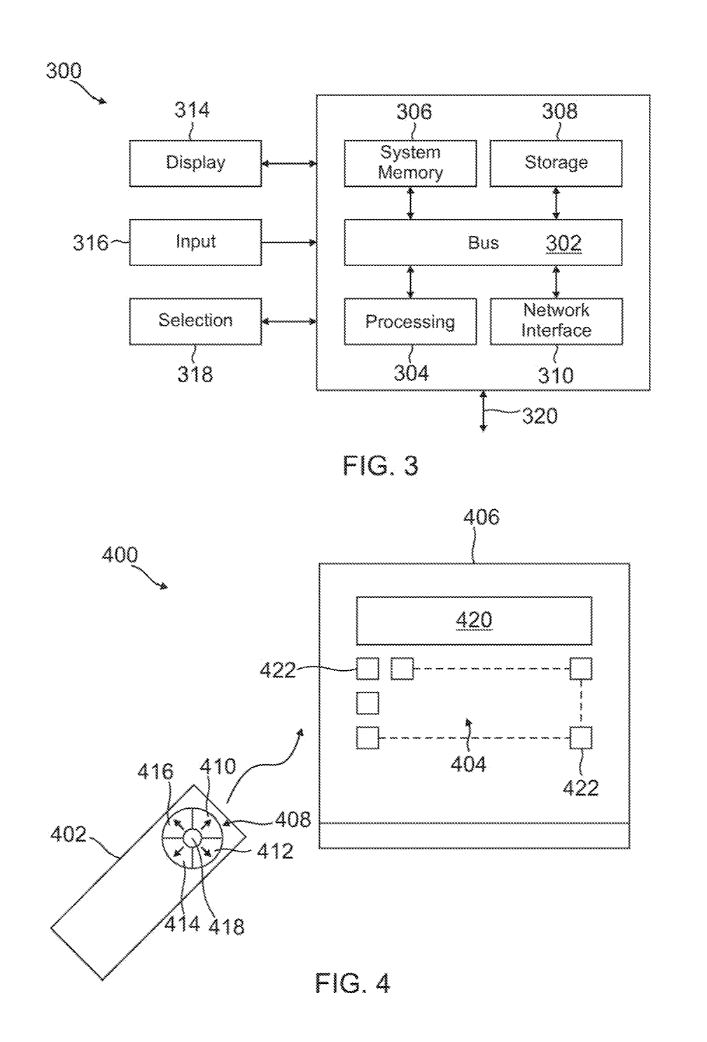

FIG. 3 is a block diagram of a device 300 according to one embodiment of a control device. Device 300 may include a bus 302 or other communication mechanism for communicating information, which interconnects subsystems and components, such as a processing component 304 (e.g., processor, micro-controller, digital signal processor (DSP), etc.), a system memory component 306 (e.g., RAM), a static storage component 308 (e.g., ROM), a network interface component 310 (e.g., modem or Ethernet card), a display component 314 (e.g., an LCD screen for displaying the virtual keyboard), an input component 316 (e.g., virtual keyboard with a touchpad interface), and/or a selection component 318 (e.g., navigation/selection wheel). Network interface component 310 may include an antenna, either separate or integrated, to enable transmission and reception via communication link 320 for wireless or wired communication.

Device 300 may perform specific operations by processor 304 executing one or more sequences of one or more instructions contained in system memory component 306, according to steps described above with respect to FIGS. 1 and 2. Such instructions may be read into system memory component 306 from another computer readable medium, such as static storage component 308. In other embodiments, hard-wired circuitry may be used in place of or in combination with software instructions to implement the invention.

Logic may be encoded in a computer readable medium, which may refer to any medium that participates in providing instructions to processor 304 for execution based on signals from input component 316 and/or selection component 318. Such a medium may take many forms, including but not limited to, non-volatile media, volatile media, and transmission media. Some common forms of computer readable media include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Device 300 may transmit and receive messages, data, information and instructions, including one or more programs (e.g., application code) through communication link 320 and communication interface 310. Received program code may be executed by processor 304. For example, once the user finishes selection through input component 316 and/or selection component 318, information may be either processed by processing component 304 or transmitted to other components through communication link 320.

FIG. 4 shows a system 400 according to another embodiment in which a free-space control 402 is used to select and correct entries on a virtual keyboard 404 shown on a separate display device 406, such as a television. Control 402 includes a navigation and select component 408 having an up arrow control 410, a right arrow control 412, a down arrow control 414, and a left arrow control 416, with a select control 418 in the middle. Note that in other embodiments, select control 418 may be separate from the arrow controls, such as directly adjacent to the bottom, top, left or right. Control 402 is pointed at display device 406 to select keys from virtual keyboard 404 shown on display device 406. Selected entries can be displayed on a screen 420. Selection on screen can be through control 402 sensing light from display device 406, such as with optical sensors and accelerometers in the control. An example of such a control is the Wii Remote from Nintendo Co., Ltd. of Kyoto, Japan. Such controls (e.g., free-space controls) allow selections on a screen to be made by simply pointing the control to a desired location on the screen.

In the embodiment shown, a user access virtual keyboard 404 for display on the screen of device 406. Virtual keyboard 404 includes a series of keys 422 that can be presented to the user in any order, although typically arranged in a QWERTY format or sequentially. Keyboard 404 may also display symbols, numbers, different case letters, etc. by the user selecting a key, either on the display or on the control.

In use, the user points control 402 toward virtual keyboard 404 and more particularly to a specific key 422 on keyboard 404. Once a specific key is selected (such as shown by the key being highlighted or an arrow or cursor being moved over the key), the user may press select control 418 to display the selection on screen 420. If the selected entry is not what the user intended, the user may simply shift or move a finger (such as the thumb) slightly to press up arrow control 410, right arrow control 412, down arrow control 414, or left arrow control 416 and move the selection to an adjacent key. If that adjacent key is still not the desired key, the user continues pressing the appropriate direction controls until the desired key is reached. Once that happens, the user enters that key by any suitable means, such as pressing select key 418 or waiting a predetermined amount of time without pressing a direction control. The positioning of the direction controls and the select control enables the user to quickly and easily correct a mistakenly entered key without looking away from display device 406 or significantly moving the user's hand or fingers on the device.

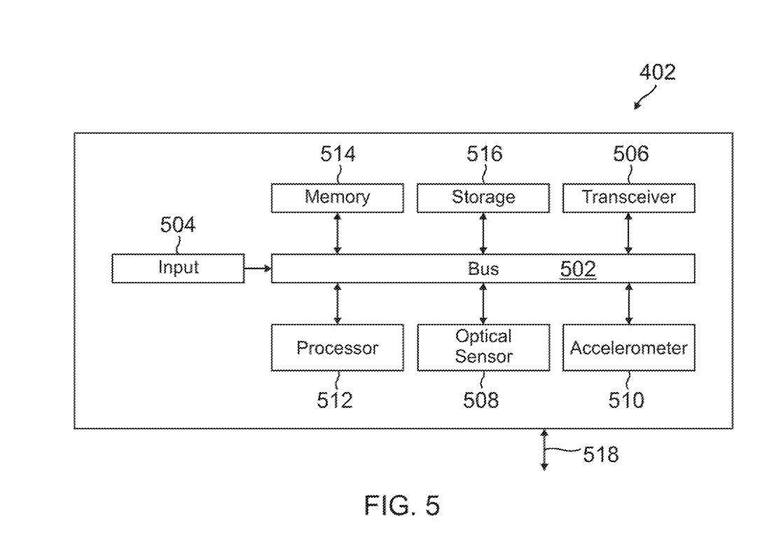

FIG. 5 is a block diagram of control 402 according to one embodiment. Control 402 includes a bus 502 or other communication mechanism for communicating information data, signals, and information between various components of control 402. Components include an input component 504 that processes a user action, such as pressing a directional control or a selection control, and sends a corresponding signal to bus 502. A transceiver 506 transmits and receives signals between control 402 and display device 406. In one embodiment, the transmission is wireless, although other transmission mediums and methods may also be suitable. An optical sensor 508 senses light from display device receives and processes the light signals. An accelerometer determines movement of control 402. An accelerometer 510 determines movement of control 402. A processor 506, which can be a micro-controller, digital signal processor (DSP), or other processing component, processes these various signals, such as for transmission to display device 406 via a communication link 518.

Components of control 402 also include a system memory component 514 (e.g., RAM) and a static storage component 516 (e.g., ROM). Control 402 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one example, transmission media may take the form of acoustic or light waves, such as those generated during radio wave, optical, and infrared data communications.

It should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof. For example, although the description focused on two types of controls, different configurations of controls, remotes, or devices may be used to practice the invention. In addition, directional arrows are shown as left, right, up, and down. Other directional arrows may also be suitable, such as diagonal arrows or arrows used with three-dimensional controls. Furthermore, the select control is shown in the middle of the arrows; however, the select control may also be placed in other locations of a control, such as the underside or a top or side location easily accessible by the user.

What is claimed is:

1. An apparatus comprising:
means for entering a key from a virtual keyboard;
a directional control for moving the entered key on the virtual keyboard to a desired key; and
a selection control at a location adjacent to the directional control for entering the desired key from the directional control.

2. The apparatus of claim 1, wherein the virtual keyboard is displayed on the apparatus.

3. The apparatus of claim 2, wherein the means comprises a touch-pad interface.

4. The apparatus of claim 1, wherein the virtual keyboard is displayed on a display device.

5. The apparatus of claim 4, wherein the means comprises an optical sensor.

6. The apparatus of claim 1, wherein the directional control comprises an up direction portion, a right direction portion, a down direction portion, and a left direction portion.

7. The apparatus of claim 6, wherein the location of the selection control is at a center area of the up, right, down, and left portions of the directional control.

8. The apparatus of claim 3, wherein the directional and selection control are located horizontally adjacent to the virtual keyboard.

9. The apparatus of claim 6, wherein the up, right, down, and left direction portions are discreet and move the entered key one key in the corresponding direction when pressed.

10. The apparatus of claim 9, wherein the entered key is moved one key at a time before entering the desired key.

11. A method of correcting, using a portable control, a key entry on a virtual keyboard, comprising:
entering a key on the virtual keyboard;
moving the entered key to a desired key using a directional control; and
confirming the desired key.

12. The method of claim 11, wherein the entering comprises tapping the key from the portable control and waiting a predetermined amount of time or tapping a subsequent key.

13. The method of claim 11, wherein the moving comprises pressing an up, down, left, or right control located horizontally adjacent to the virtual keyboard.

14. The method of claim 11, wherein the entering comprises pointing the control at a display device displaying the virtual keyboard.

15. The method of claim 14, wherein the moving comprises pressing an up, down, left, or right control.

16. The method of claim 11, wherein the confirming comprises pressing a selection control located in the middle of the up, down, left, and right controls.

17. The method of claim 11, wherein the moving comprises moving to the desired key one key at a time.

18. An apparatus comprising:
means for entering a key on a virtual keyboard;
means for moving the entered key to a desired key using a directional control; and
means for confirming the desired key.

19. The apparatus of claim 18, wherein the means for entering comprises an optical sensor.

20. The apparatus of claim 19, wherein the virtual keyboard is displayed on a separate display apparatus.

21. The apparatus of claim 18, wherein the means for entering comprises a touch pad interface for the virtual keyboard.

22. The apparatus of claim 21, wherein the virtual keyboard is displayed horizontally adjacent to the means for confirming on the apparatus.

23. The apparatus of claim 18, wherein the means for moving comprises discrete up, down, left, and right portions on the apparatus.

24. The apparatus of claim 23, wherein the means for confirming comprises a select control located in the middle of the up, down, left, and right portions.
